(19) United States
(12) Patent Application Publication
(10) Pub. No.: US 2026/0270121 A1
(43) Pub. Date: Sep. 10, 2026

(54) Enhanced PTRS to DMRS Port Mapping for Multi-Codeword and Multi-Panel Transmission

(71) Applicant: TELEFONAKTIEBOLAGET LM ERICSSON (PUBL), Stockholm (SE)

(72) Inventors: Sven Jacobsson, Västra Frölunda (SE); Andreas Nilsson, Göteborg (SE)

(21) Appl. No.: 19/102,982

(22) PCT Filed: Aug. 11, 2023
(86) PCT No.: PCT/EP2023/072305

§ 371 Date: Feb. 11, 2025

Related U.S. Application Data
(60) Provisional application No. 63/397,673, filed on Aug. 12, 2022.

(51) Int. Cl. H04L 25/03; H04L 1/00; H04L 1/1607; H04L 5/00

(52) U.S. Cl. CPC H04L 25/03929; H04L 1/0003; H04L 1/1614; H04L 5/0051

(57) ABSTRACT

The present disclosure describes several methods on how to perform an overhead-efficient indication of a phase tracking reference signals (PTRS) to demodulation reference signals (DMRS) mapping for user equipment (UEs) (20, 100) with up to 8 layers, up to 4 PTRS ports, up to 4 simultaneously transmitting UE panels, and up to 4 uplink (UL) codewords, up to 8 layers per UE panel (110), which can reduce the downlink control information (DCI) overhead for UL communication.

### TECHNICAL FIELD

The present disclosure relates generally to phase tracking reference signals (PTRS) for use in wireless communication systems and, more particularly, to mapping of PTRS ports to uplink layers for uplink transmission in a multiple-input, multiple-output (MIMO) system.

### BACKGROUND

In the current Third Generation Partnership Project (3GPP) specification, demodulation reference signals (DMRS) are used for coherent demodulation of physical layer data channels, such as the Physical Downlink Shared Channel (PDSCH) and the Physical Uplink Shared Channel (PUSCH). The DMRS is confined to resource blocks carrying the associated physical layer channel and is mapped on allocated resource elements of the time-frequency resource grid such that the receiver can efficiently handle time/frequency-selective fading radio channels.

In New Radio (NR), phase tracking reference signals (PTRS) can also be configured for PUSCH transmission in order for the receiver to correct phase-noise related errors. In NR Release15 (Rel-15), for Cyclic Prefix Orthogonal Frequency Division Multiplexing (CP OFDM) based waveforms, either one or two PTRS ports for PUSCH are supported. Each PTRS port is associated with one of the DMRS ports for the PUSCH.

In the current standards, the PTRS to DMRS mapping (i.e., the indication used in downlink control information (DCI) to indicate which DMRS Port the PTRS ports should be associated with) is only designed for up to 2 PTRS ports, up to 4 uplink (UL) layers, and up to 1 UL codeword. In NR Rel-18, the number of UL layers will be increased to 8, the number of simultaneously transmitted UE panels will be increased to 2, and the number of UL codewords will most likely be increased to two. In later releases for NR and 6G, the extension to number of simultaneously transmitting UE panels, the maximum number of UL layers and maximum numbers of codewords might be extended even further since it is expected that multiple transmission-reception points (TRPs) with more than 2 TRPs and distributed Multiple Input Multiple Output (D MIMO) applications will be introduced in 5G advance and/or 6G. In addition, UL is becoming the limiting factor in wireless communication, which has generated a constant push from operators to introduce further UL specification enhancements in 3GPP. In addition, more advanced UEs will become available on the future market, like fixed wireless access (DWA), connected vehicles, robots, machines etc., where more advanced transmit antenna architectures will be used (with for example more than 2 UE panels at millimeter wave (mmWave) frequencies, and/or more than 2 ports per UE panel).

How to make an overhead efficient PTRS to DMRS mapping for cases with extended number of UL layers, UL codewords, simultaneously transmitting UE panels etc., is an open issue that needs to be solved.

### SUMMARY

It may be an object of the invention to provide measures with which a overhead efficient PTRS to DMRS mapping for cases with extended number of UL layers, extended number of UL codewords, and/or extended number of simultaneously transmitting UE panels can be enabled.

The present disclosure describes several methods on how to perform an overhead-efficient indication of a phase tracking reference signals (PTRS) to demodulation reference signals (DMRS) mapping for user equipment (UEs) with up to 8 layers, up to 4 PTRS ports, up to 4 simultaneously transmitting UE panels, and up to 4 uplink (UL) codewords, up to 8 layers per UE panel, which can reduce the downlink control information (DCI) overhead for UL communication.

One exemplary embodiment of the present disclosure comprises a method of transmitting PTRS implemented by a wireless device in a wireless communication system using multi-layer transmission on the uplink. The method comprises receiving a message containing a mapping parameter having a value indicative of one of a plurality of entries in a mapping table. Each entry in the mapping table is associated with at least one of one or more codewords used for uplink transmission of reference signals. The method further comprises, allocating one or more PTRS ports to respective uplink layers based on the indicated entry in the mapping table and transmitting the PTRS over the allocated PTRS ports.

Another exemplary embodiment of the present disclosure comprises a method of transmitting PTRS implemented by a wireless device in a wireless communication systems using multi-layer transmission on the uplink. The method comprises receiving a message containing a mapping parameter having a value indicative of one of a plurality of entries in a mapping table. Each entry in the mapping table is associated with at least one of a plurality of antenna panels used for uplink transmission of reference signals. The method further comprises, allocating one or more PTRS ports to respective uplink layers based on the indicated entry in the mapping table and transmitting the PTRS over the allocated PTRS ports.

Another exemplary embodiment of the invention comprises a method of transmitting PTRS implemented by a wireless device in a wireless communication systems using multi-layer transmission on the uplink. The method comprises indicating to a network node, a capability for reciprocity based mapping of PTRS to uplink layers. The method further comprises, determining a strongest uplink layer based on reception of downlink signals from the network node. The method further comprises, adapting a mapping between sounding reference signal (SRS) ports or SRS resources such that the lowest SRS port index or lowest SRS resource index is associated with the strongest uplink layer. The method further comprises, allocating the PTRS to the strongest uplink layer without explicit signaling from the network node to indicate the uplink layer for PTRS.

Another exemplary embodiment of the present disclosure comprises a method of receiving PTRS implemented by a network node in a wireless communication systems using multi-layer transmission on the uplink. The method comprises, sending, to a UE, a message containing a mapping parameter having a value indicative of one of a plurality of entries in a mapping table. Each entry in the mapping table is associated with at least one of one or more codewords used for uplink transmission of reference signals and indicates an allocation of one or more PTRS ports to respective uplink layers. The method further comprises, receiving the PTRS over the allocated PTRS ports.

Another exemplary embodiment of the present disclosure comprises a method of receiving PTRS implemented by a network node in a wireless communication systems using multi-layer transmission on the uplink. The method comprises, sending, to a UE, a message containing a mapping parameter having a value indicative of one of a plurality of entries in a mapping table. Each entry is associated with at least one of a plurality of antenna panels used for uplink transmission of reference signals and indicates an allocation of one or more PTRS ports to respective uplink layers. The method further comprises, receiving the PTRS over the allocated PTRS ports.

Another exemplary embodiment of the present disclosure comprises a method of receiving PTRS implemented by a network node in a wireless communication systems using multi-layer transmission on the uplink. The method comprises receiving, from a UE, an indication of a UE capability for reciprocity based mapping of PTRS to uplink layers. The method further comprises, determining a strongest uplink layer. The method further comprises, receiving the PTRS from the UE on the strongest uplink layer without explicit signaling to the UE to indicate the uplink layer for PTRS.

Another exemplary embodiment of the present disclosure comprises a wireless device in a wireless communication systems using multi-layer transmission on the uplink and configured to transmit PTRS. The wireless device is configured to receive a message containing a mapping parameter having a value indicative of one of a plurality of entries in a mapping table. Each entry in the mapping table is associated with at least one of one or more codewords used for uplink transmission of reference signals. The wireless device is further configured to allocate one or more PTRS ports to respective uplink layers based on the indicated entry in the mapping table and transmit the PTRS over the allocated PTRS ports.

Another exemplary embodiment of the present disclosure comprises a wireless device in a wireless communication systems using multi-layer transmission on the uplink and configured to transmit PTRS. The wireless device comprises communication circuitry for communicating with a network node and processing circuitry. The processing circuitry is configured to receive a message containing a mapping parameter having a value indicative of one of a plurality of entries in a mapping table. Each entry in the mapping table is associated with at least one of one or more codewords used for uplink transmission of reference signals. The processing circuitry is further configured to allocate one or more PTRS ports to respective uplink layers based on the indicated entry in the mapping table and transmit the PTRS over the allocated PTRS ports.

Another exemplary embodiment of the present disclosure comprises a wireless device in a wireless communication systems using multi-layer transmission on the uplink and configured to transmit PTRS. The wireless device is configured to receive a message containing a mapping parameter having a value indicative of one of a plurality of entries in a mapping table. Each entry in the mapping table is associated with at least one of a plurality of antenna panels used for uplink transmission of reference signals. The wireless device is further configured to allocate one or more PTRS ports to respective uplink layers based on the indicated entry in the mapping table and transmit the PTRS over the allocated PTRS ports.

Another exemplary embodiment of the present disclosure comprises a wireless device in a wireless communication systems using multi-layer transmission on the uplink and configured to transmit PTRS. The wireless device comprises communication circuitry for communicating with a network node and processing circuitry. The processing circuitry is configured to receive a message containing a mapping parameter having a value indicative of one of a plurality of entries in a mapping table. Each entry in the mapping table is associated with at least one of a plurality of antenna panels used for uplink transmission of reference signals. The processing circuitry is further configured to allocate one or more PTRS ports to respective uplink layers based on the indicated entry in the mapping table and transmit the PTRS over the allocated PTRS ports.

Another exemplary embodiment of the present disclosure comprises a wireless device in a wireless communication systems using multi-layer transmission on the uplink and configured to transmit PTRS. The wireless device is configured to indicate to a network node, a capability for reciprocity based mapping of PTRS to uplink layers. The wireless device is further configured to determine a strongest uplink layer based on reception of downlink signals from the network node. The wireless device is further configured to adapt a mapping between SRS ports or SRS resources such that the lowest SRS port index or lowest SRS resource index is associated with the strongest uplink layer. The wireless device is further configured to allocate the PTRS to the strongest uplink layer without explicit signaling from the network node to indicate the uplink layer for PTRS.

Another exemplary embodiment of the present disclosure comprises a wireless device in a wireless communication systems using multi-layer transmission on the uplink and configured to transmit PTRS. The wireless device comprises communication circuitry for communicating with a network node. The processing circuitry is configured to indicate to a network node, a capability for reciprocity based mapping of PTRS to uplink layers. The processing circuitry is further configured to determine a strongest uplink layer based on reception of downlink signals from the network node. The processing circuitry is further configured to adapt a mapping between SRS ports or SRS resources such that the lowest SRS port index or lowest SRS resource index is associated with the strongest uplink layer. The processing circuitry is further configured to allocate the PTRS to the strongest uplink layer without explicit signaling from the network node to indicate the uplink layer for PTRS.

Another exemplary embodiment of the present disclosure comprises a network node in a wireless communication systems using multi-layer transmission on the uplink and configured to receive PTRS from a UE. The network node is configured to send, to a UE, a message containing a mapping parameter having a value indicative of one of a plurality of entries in a mapping table. Each entry is associated with at least one of one or more codewords used for uplink transmission of reference signals and indicates an allocation of one or more PTRS ports to respective uplink layers. The network node is further configured to receive the PTRS over the allocated PTRS ports.

Another exemplary embodiment of the present disclosure comprises a network node in a wireless communication systems using multi-layer transmission on the uplink and configured to receive PTRS from a UE. The network node comprises communication circuitry for communicating with the UE and processing circuitry. The processing circuitry is configured to send, to a UE, a message containing a mapping parameter having a value indicative of one of a plurality of entries in a mapping table. Each entry is associated with at least one of one or more codewords used for uplink transmission of reference signals and indicates an allocation of one or more PTRS ports to respective uplink layers. The processing circuitry is further configured to receive the PTRS over the allocated PTRS ports.

Another exemplary embodiment of the present disclosure comprises a network node in a network node in a wireless communication systems using multi-layer transmission on the uplink. The network node is configured to receive PTRS from a UE. The network node is further configured to send, to a UE, a message containing a mapping parameter having a value indicative of one of a plurality of entries in a mapping table. Each entry is associated with at least one of a plurality of antenna panels used for uplink transmission of reference signals and indicates an allocation of one or more PTRS ports to respective uplink layers. The network node is further configured to receive the PTRS over the allocated PTRS ports.

Another exemplary embodiment of the present disclosure comprises a network node in a network node in a wireless communication systems using multi-layer transmission on the uplink. The network node is configured to receive PTRS from a UE. The network node comprises communication circuitry for communicating with the UE. The network node further comprises processing circuitry configured to send, to a UE, a message containing a mapping parameter having a value indicative of one of a plurality of entries in a mapping table. Each entry is associated with at least one of a plurality of antenna panels used for uplink transmission of reference signals and indicates an allocation of one or more PTRS ports to respective uplink layers. The processing circuitry is further configured to receive the PTRS over the allocated PTRS ports.

Another exemplary embodiment of the present disclosure comprises a network node in a wireless device in a wireless communication systems using multi-layer transmission on the uplink. The network node is configured to transmit PTRS from a UE. The wireless device is configured to receive, from the UE, an indication of a UE capability for reciprocity based mapping of PTRS to uplink layers. The wireless device is further configured to determine a strongest uplink layer. The wireless device is further configured to receive the PTRS from the UE on the strongest uplink layer without explicit signaling to the UE to indicate the uplink layer for PTRS.

Another exemplary embodiment of the present disclosure comprises a network node in a wireless device in a wireless communication systems using multi-layer transmission on the uplink configured to transmit PTRS. The wireless device comprises communication circuitry for communicating with a network node. The wireless device further comprises processing circuitry configured to receive, from the UE, an indication of a UE capability for reciprocity based mapping of PTRS to uplink layers. The processing circuitry is further configured to determine a strongest uplink layer. The processing circuitry is further configured to receive the PTRS from the UE on the strongest uplink layer without explicit signaling to the UE to indicate the uplink layer for PTRS.

### BRIEF DESCRIPTION OF THE DRAWINGS

FIG. 1 illustrates an exemplary wireless communication network.

FIG. 2 illustrates a NR time-domain structure with 15 kHz subcarrier spacing

FIG. 3 illustrates a NR physical resource grid.

FIG. 4 illustrates a front-loaded demodulation reference signal (DMRS) for configuration type 1 and type 2 where different code division multiplexing (CDM) groups are indicated by different shading.

FIG. 5 illustrates exemplary DMRS configurations for Physical Downlink Shared Channel (PDSCH) Mapping Type A.

FIG. 6 illustrates exemplary DMRS configurations for PDSCH Mapping Type B.

FIG. 7 illustrates an exemplary PTRS resource elements (REs) in a resource block (RB) with time density 2 and subcarrier offset of 4.

FIG. 8 illustrates a PTRS-DMRS Association table for one PTRS port, 1 UL codeword, and with maximum 8 UL layers (left) and with maximum 4 UL layers (right), according to some embodiments of the present disclosure.

FIG. 9 illustrates a PTRS-DMRS Association table for one PTRS port, 1 UL codeword, and with maximum 6 UL layers, and where the number of entries in the table are rounded down to four, according to some embodiments of the present disclosure.

FIG. 10 illustrates a PTRS-DMRS Association table for one PTRS port, 2 UL codewords, and with maximum 8 UL layers, according to some embodiments of the present disclosure.

FIG. 11 illustrates a PTRS-DMRS Association table for one PTRS port, 4 UL codewords, and with maximum 8 UL layers, according to some embodiments of the present disclosure.

FIG. 12 illustrates SRS port to antenna port mapping, according to some embodiments of the present disclosure.

FIG. 13 illustrates a PTRS-DMRS Association table for 2 PTRS ports, 1 UL codeword, maximum 8 UL layers and with 4 UE panels/antenna modules, according to some embodiments of the present disclosure.

FIG. 14 illustrates a PTRS DMRS Association table for 2 PTRS ports, 2 codewords and up to 8 UL layers where the entries are divided into two parts, for the first codeword and a second codeword, according to some embodiments of the present disclosure.

FIG. 15 illustrates PTRS-DMRS Association table for 2 PTRS ports, 4 codewords and up to 8 UL layers, where the entries are divided into two parts, for a first codeword and a second codeword, according to some embodiments of the present disclosure.

FIG. 16 illustrates a PTRS-DMRS Association table for 2 configured UL PTRS ports and 4 configured UL codewords and up to 8 UL layers, according to some embodiments of the present disclosure.

FIG. 17 illustrates a PTRS-DMRS Association table for 2 PTRS ports, 1 or 2 UL codewords, and up to 4 UL layers according to some embodiments of the present disclosure.

FIG. 18 a PTRS-DMRS Association table for 4 PTRS ports, 4 codewords, and up to 8 UL layers, according to some embodiments of the present disclosure.

FIG. 19 illustrates a PTRS DMRS Association table for 4 PTRS ports and four SRS resource sets, according to some embodiments of the present disclosure.

FIG. 20 illustrates an exemplary method for transmitting PTRS implemented by a wireless device in a wireless communication system using multi-layer transmission on the uplink.

FIG. 21 illustrates a method for transmitting PTRS implemented by a wireless device in a wireless communication system using multi-layer transmission on the uplink.

FIG. 22 illustrates a method for transmitting PTRS implemented by a wireless device in a wireless communication system using multi-layer transmission on the uplink.

FIG. 23 illustrates a method for receiving PTRS implemented by network node in a wireless communication systems using multi-layer transmission on the uplink.

FIG. 24 illustrates a method for receiving PTRS implemented by a network node in a wireless communication systems using multi-layer transmission on the uplink.

FIG. 25 illustrates a method for receiving PTRS implemented by a network node in a wireless communication systems using multi-layer transmission on the uplink.

FIG. 26 illustrates a UE configured for transmitting PTRS.

FIG. 27 illustrates a base station/network node configured for receiving PTRS.

### DETAILED DESCRIPTION

The present disclosure will be described in the context of a Fifth Generation (5G) network implementing the New Radio (NR) air interface. Those skilled in the art will appreciate that the techniques herein described are more generally applicable to any wireless communication network implementing PTRS on the uplink.

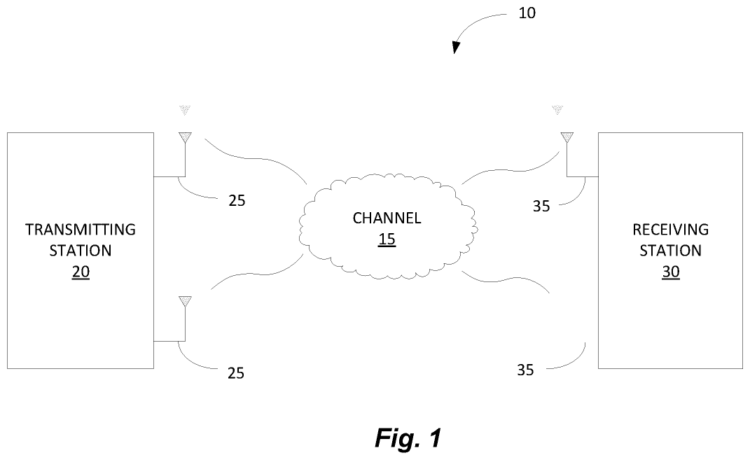

FIG. 1 illustrates a multiple input, multiple output (MIMO) wireless communication system 10 including a transmitting station 20 and a receiving station 30 communicating over a MIMO channel 15. For downlink communications, transmitting station 20 comprises a network node or base station, also referred to as a 5G NodeB (gNB) in NR, and receiving station 30 comprises a user equipment (UE). Examples of UEs include cellular telephones, smart phones, tablets, notebooks, laptop computers, laptop mounted equipment (LME), vehicle-to-vehicle (V2V) communication devices, vehicle-to-everything (V2X) communication devices, machine type communication (MTC) devices, Machine-to-machine M2M communication devices, etc. For uplink communications, transmitting station 20 comprises a UE and receiving station 30 comprises a base station (e.g., gNB). Both the transmitting station 20 and receiving station 30 have multiple antennas 25, 35. The use of multiple antennas 25, 35 at both the transmitting station 20 and receiving station 30 enables spatial multiplexing, a multi-antenna transmission technique where multiple data streams are transmitted in different spatial layers using the same time/frequency resources. Spatial multiplexing enables higher data rates and more efficient use of spectral resources. To enable spatial multiplexing, DMRS are transmitted on each spatial layer to enable coherent demodulation at the receiver as hereinafter described.

### NR Frame Structure and Resource Grid

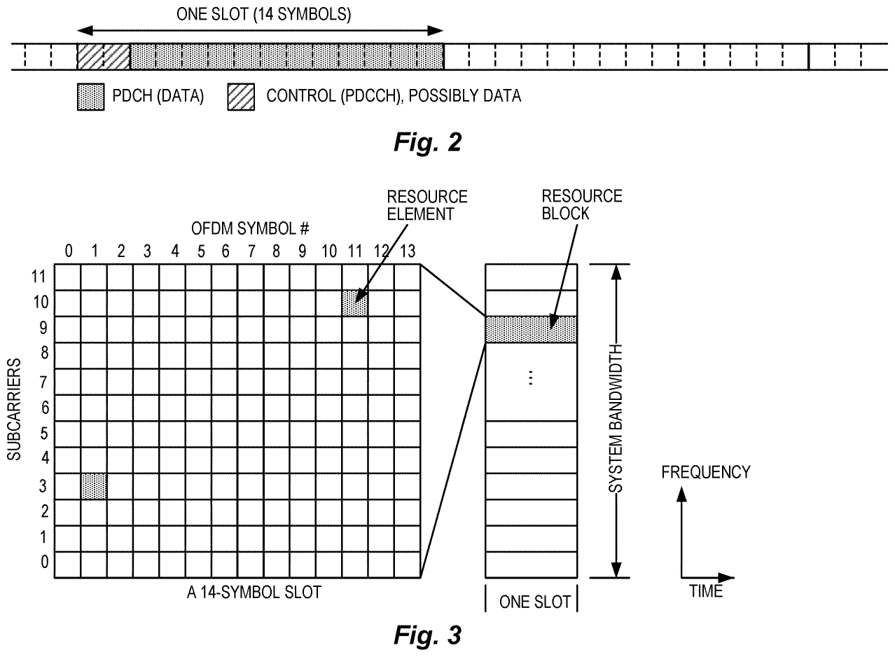

FIG. 2 illustrates a NR time-domain structure with 15 kHz subcarrier spacing. NR uses Cyclic Prefix Orthogonal Frequency Division Multiplexing (CP-OFDM) in both downlink (i.e., from a network node, gNB, or base station, to a UE) and uplink (i.e., from UE to gNB). Discrete Fourier Transform (DFT) spread Orthogonal Frequency Division Multiplexing (DFT-S-OFDM) is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe and each slot consists of 14 OFDM symbols.

Data scheduling in NR is typically performed on a slot basis. The example shown in FIG. 2 for a NR time-domain structure with 15 kHz subcarrier spacing and a 14-symbol slot, the first two symbols contain Physical Downlink Control Channel (PDCCH) and the remaining slots contain the physical layer data channel, which may comprise either the Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15× 2^{μ}) kHz where μ∈0,1,2,3,4. Δf=15 kHz is the basic subcarrier spacing. The slot durations at different subcarrier spacings are given by

$$\frac{1}{{2}^{μ}} ms .$$

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in FIG. 3, where only one RB within a 14-symbol slot is shown. One OFDM subcarrier during one OFDM symbol interval forms one resource element (RE).

Downlink (DL) PDSCH transmissions can be either dynamically scheduled, i.e., in each slot the gNB transmits downlink control information (DCI) over PDCCH (Physical Downlink Control Channel) about which UE data is to be transmitted to and which RBs in the current downlink slot the data is transmitted on, or semi-persistently scheduled (SPS) in which periodic PDSCH transmissions are activated or deactivated by DCI. Different DCI formats are defined in NR for DL PDSCH scheduling including DCI format 1_0, DCI format 1_1, and DCI format 1_2.

Similarly, uplink (UL) PUSCH transmission can also be scheduled either dynamically or semi-persistently with uplink grants carried in the PDCCH. NR supports two types of semi-persistent uplink transmission, i.e., type 1 configured grant (CG) and type 2 CG, where Type 1 CG is configured and activated by Radio Resource Control (RRC) while Type 2 CG is configured by Radio Resource Control (RRC) but activated/deactivated by DCI. The DCI formats for scheduling PUSCH include DCI format 0_0, DCI format 0_1, and DCI format 0_2.

DMRS configuration

Demodulation Reference Signals (DMRS) are used for coherent demodulation of physical layer data channels, i.e., PDSCH and PUSCH, as well as the PDCCH. The DMRS is confined to resource blocks carrying the associated physical layer channel and is mapped on allocated REs of the time-frequency resource grid such that the receiver can efficiently handle time/frequency-selective fading radio channels.

The mapping of DMRS to REs is configurable in both frequency and time domain. There are two mapping types in the frequency domain, i.e., type 1 and type 2. In addition, there are two mapping types in the time domain, i.e., mapping type A and type B, which defines the symbol position of the first OFDM symbol containing DMRS within a transmission interval.

The DMRS mapping in time domain can further be single-symbol based or double-symbol based, where the latter means that DMRS is mapped in pairs of two adjacent OFDM symbols. For single symbol based DMRS, a UE can be configured with one, two, three, or four single-symbol DMRS (also referred to as additional DMRS) in a slot. For double-symbol based DMRS, a UE can be configured with one or two such double-symbol DMRS in a slot. In scenarios with low Doppler, it may be sufficient to configure front-loaded DMRS only, i.e., one single-symbol DMRS or one double-symbol DMRS. In scenarios with high Doppler, additional DMRS will be required in a slot.

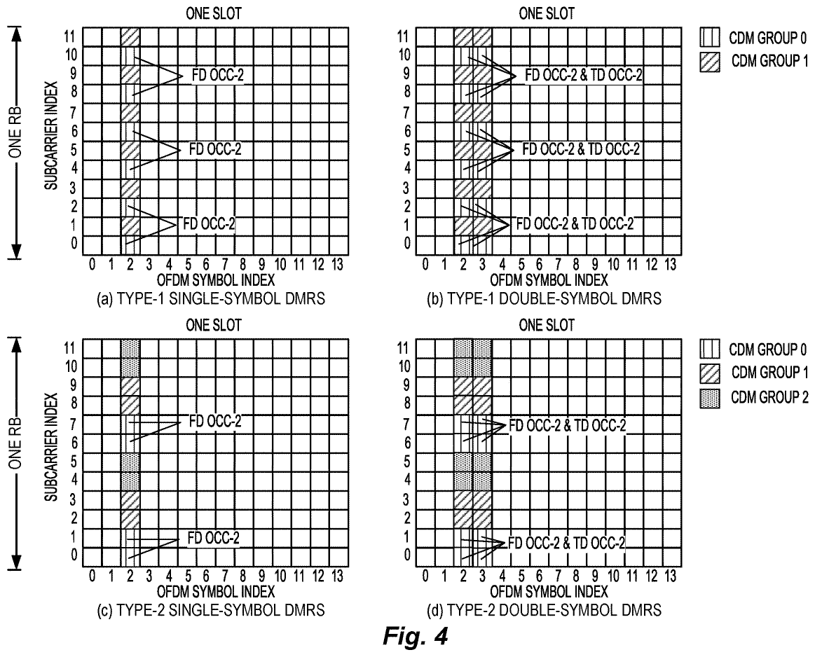

FIG. 4. shows an example of type 1 and type 2 front-loaded DMRS with single-symbol and double-symbol DMRS and time domain mapping type A with first DMRS in the third OFDM symbol of a transmission interval of 14 symbols. As shown in FIG. 4, type 1 and type 2 differ with respect to both the mapping structure and the number of supported DMRS Code Division Multiplexing (CDM) groups where type 1 supports 2 CDM groups and Type 2 support 3 CDM groups.

A DMRS antenna port is mapped to the REs within one CDM group only. For single-symbol DMRS, two antenna ports can be mapped to each CDM group whereas for double-symbol DMRS four antenna ports can be mapped to each CDM group. Hence, for DMRS type 1, the maximum number of DMRS ports is four for a single-symbol based DMRS configuration and eight for double-symbol based DMRS configuration. For DMRS type 2, the maximum number of DMRS ports is six for a single-symbol based DMRS configuration and twelve for double-symbol based DMRS configuration.

An orthogonal cover code (OCC) of length 2 (i. e., [+1, +1] or [+1, −1]) is used to separate antenna ports mapped in the same two REs within a CDM group. The OCC is applied in frequency domain (FD) as well as in time domain (TD) when double-symbol DMRS is configured. The OCC is illustrated in FIG. 4 for CDM group 0.

In NR Rel-15, the mapping of a PDSCH DMRS sequence r(m), m=0,1, . . . on antenna port p and subcarrier k in OFDM symbol l for the numerology index μ is specified in 3GPP TS 38.211 e.g. V17.2.0 (2022-06) as:

$${a}_{k , l}^{( p , μ )} = {β}_{PDSCH}^{DMRS} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

where w_{f} (k′) represents 2 OCC code and wₜ (l′) represents a time domain length 2 OCC code.

Table 1 and Table 2 show the PDSCH DMRS mapping parameters for configuration type 1 and type 2, respectively.

TABLE 1
PDSCH DMRS mapping parameters for configuration type 1.

| | CDM | | w_{f} (k′) | | wₜ (l′) | |
|---|---|---|---|---|---|---|
| p | [symbol] | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

[symbol]

indicates data missing or illegible when filed

TABLE 2
PDSCH DMRS mapping parameters for configuration type 2.

| | CDM | | w_{f} (k′) | | wₜ (l′) | |
|---|---|---|---|---|---|---|
| p | [symbol] | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

[symbol]

indicates data missing or illegible when filed

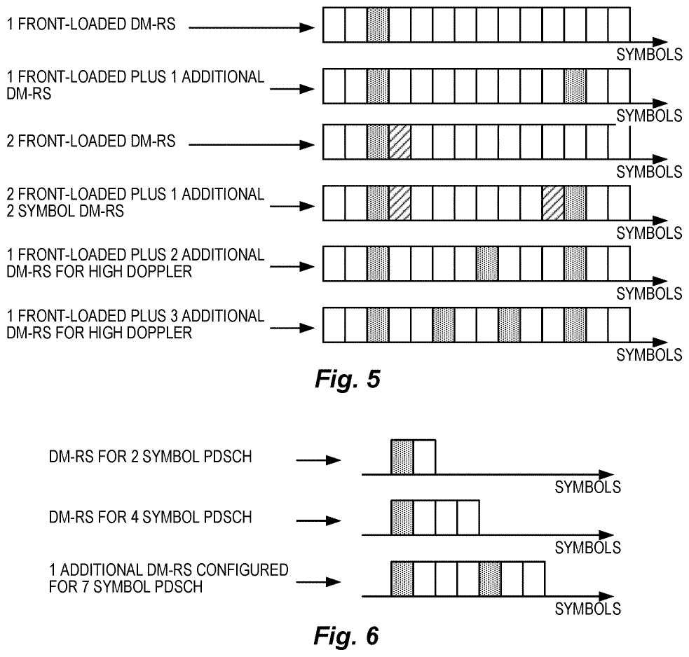

For PDSCH mapping type A, DMRS mapping is relative to slot boundary. That is, the first front-loaded DMRS symbol in DMRS mapping type A is in either the 3^{rd} or 4^{th} symbol of the slot. In addition to the front-loaded DMRS, type A DMRS mapping can consist of up to 3 additional DMRS. Some examples of DMRS for mapping type A are shown in FIG. 5 (note that PDSCH length of 14 symbols is assumed in the examples).

FIG. 5 assumes that the PDSCH duration is the full slot. If the scheduled PDSCH duration is shorter than the full slot, the positions of the DMRS changes according to the specification TS 38.211, e.g. V17.2.0 (2022-06).

For PDSCH mapping type B, DMRS mapping is relative to transmission start. That is, the first DMRS symbol in DMRS mapping type B is in the first symbol in which type B PDSCH starts. Some examples of DMRS for mapping type B are shown in FIG. 6.

The same DMRS design for PDSCH is also applicable for PUSCH when transform precoding is not enabled, where the sequence r(m) shall be mapped to the intermediate quantity

$${\tilde{a}}_{k , l}^{( {\tilde{p}}_{j} , μ )}$$

for DMRS port \tilde{p}ⱼ according to

$${\tilde{a}}_{k , l}^{( {\tilde{p}}_{j} , μ )} = {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$j = 0 , 1 , … , v - 1$$

where w_{f}(k′), wₜ(l′), and Δ are given by Tables 6.4.1.1.3-1 and 6.4.1.1.3-2 in TS 38.211 e.g. V17.2.0 (2022-06), which are reproduced below, and v is the number of PUSCH transmission layers. The intermediate quantity

$${\tilde{a}}_{k , l}^{( {\tilde{p}}_{j} , μ )} = 0$$

if Δcorresponds to any other antenna ports than \tilde{p}ⱼ.

The intermediate quantity

$${\tilde{a}}_{k , l}^{( {\tilde{p}}_{j} , μ )}$$

shall be precoded, multiplied with the amplitude scaling factor

$${β}_{PDSCH}^{DMRS}$$

in order to conform to the transmit power specified in clause 6.2.2 of TS 38.214, e. g. V17.2.0 (2022-06), and mapped to physical resources according to:

$$[ \begin{matrix}{a}_{k , l}^{( {p}_{0} , μ )} \\ ⋮ \\ {a}_{k , l}^{( {p}_{ρ - 1} , μ )}\end{matrix} ] = {β}_{PUSCH}^{DMRS} W [ \begin{matrix}{\tilde{a}}_{k , l}^{( {\tilde{p}}_{0} , μ )} \\ ⋮ \\ {\tilde{a}}_{k , l}^{( {\tilde{p}}_{υ - 1} , μ )}\end{matrix} ]$$

where the precoding matrix W is given by clause 6.3.1.5 of TS 38.211 e.g. V17.2.0 (2022-06), {p₀, . . . , pₚ₋₁} is a set of physical antenna ports used for transmitting the PUSCH, and {\tilde{p}₀, . . . , \tilde{p}ᵤ₋₁} is a set of DMRS ports for the PUSCH.

TABLE 64.1.1.3-1
Parameters for PUSCH DMRS configuration type 1.

| | CDM | | w_{f} (k′) | | wₜ (l′) | |
|---|---|---|---|---|---|---|
| \tilde{p} | group λ | Δ | k′ = 0 | k′ = 1 | k′ = 0 | k′ = 1 |
| 0 | 0 | 0 | +1 | +1 | +1 | +1 |
| 1 | 0 | 0 | +1 | - 1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 6.4.1.1.3-2
Parameters for PUSCH DMRS configuration type 2.

| | CDM | | w_{f} (k′) | | wₜ (l′) | |
|---|---|---|---|---|---|---|
| \tilde{p} | group λ | Δ | k′ = 0 | k′ = 1 | p | group λ |
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

### PTRS for PUSCH in NR

In NR, PTRS can be configured for PUSCH transmissions in order for the receiver to correct phase-noise-related errors. PTRS can be configured with the higher layer parameter PTRS-UplinkConfig in DMRS-UplinkConfig for PUSCH scheduled by DCI format 0_1 or DCI format 0_2.

In NR Rel. 15, for CP OFDM based waveform, either one or two PTRS ports for PUSCH are supported. Each PTRS port is associated with one of the DMRS ports for the PUSCH.

If more than one DMRS port is scheduled, i.e., multi-layer MIMO transmission of PUSCH, it is desirable from a performance perspective for the PTRS to be transmitted in the layer having the highest Signal to Interference plus Noise Ratio (SINR). This approach will maximize the phase-tracking performance. The network knows which layer has the best SINR based on measurements of the multi-port sounding reference signals (SRS). Hence, the network can, when scheduling the PUSCH from the UE, indicate which layer the UE shall use to transmit the PTRS. This indication is signaled using PTRS-DMRS association, as defined below.

The maximum number of configured PTRS ports is given by the higher layer parameter maxNrofPorts in PTRS-UplinkConfig based on UE reported need. If a UE has reported the capability of supporting full-coherent UL transmission, one PTRS port is expected to be configured if needed.

In the frequency domain, for CP OFDM based waveform, a PTRS can be in at most one subcarrier per 2 Physical Resource Blocks (PRBs). Also, the subcarrier used for a PTRS port must be one of the subcarriers also used for the DMRS port associated with the PTRS port. For DMRS configuration type 1, a DMRS port is mapped to every second subcarrier. Consequently, an associated PTRS can only be mapped to one out of 6 subcarriers. An offset can be configured to determine which subcarrier the DMRS is mapped to (see Table 6.4.1.2.2.1-1 in 3gpp TS 38.211, e.g. V17.2.0 (2022-06)).

In the time domain, a PTRS can be configured with a time density of 1, 2, or 4, corresponding to PTRS in every OFDM symbol, every second OFDM symbols, or every fourth OFDM symbol in a slot, respectively. The modulated symbol used for the PTRS is the same as the associated DMRS at the same subcarrier.

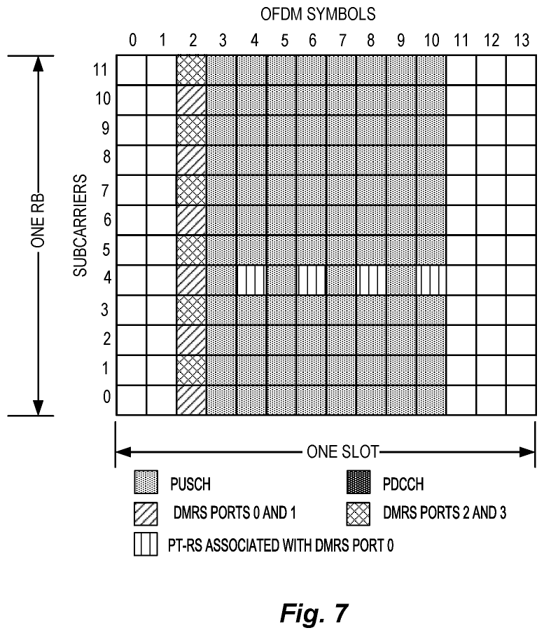

FIG. 7 illustrates an example of PTRS REs in a RB with time density 2 and subcarrier offset of 4 for CP OFDM based waveform. In this example, the PTRS port is associated with DMRS port 0 and has a subcarrier offset of 4 and a time density of 2.

For codebook or non-codebook-based UL transmission, the association between UL PTRS port(s) and DMRS port(s) is signaled by a PTRS DMRS Association field in DCI format 0_1 and DCI format 0_2.

If the UE is configured with one PTRS port, the DMRS port associated with the PTRS port is indicated by DCI parameter PTRS DMRS association in DCI format 0_1 and DCI format 0_2 in Table 7.3.1.1.2-25 of 3GPP TS 38.212 e.g. V17.2.0 (2022-06), which is reproduced below. As discussed above, the purpose is to schedule the PTRS to be transmitted on the strongest layer/DMRS port (since there is one DMRS port per layer).

TABLE 7.3.1.1.2-25
PTRS-DMRS association for UL PTRS port 0 Value

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

For non-codebook-based UL transmission, the actual number of PTRS port(s) to transmit is determined based on Sounding Reference Signal (SRS) Resource Indicators SRI(s) in DCI format 0_1 and DCI format 0_2. A UE is configured with the PTRS port index for each configured SRS resource by the higher layer parameter ptrs-PortIndex configured by SRS-Config. 1f the PTRS port index associated with different SRIs are the same, the corresponding UL DMRS ports are associated to the one PTRS port.

For partial-coherent and non-coherent codebook-based UL transmission, the actual number of UL PTRS port(s) is determined based on Transmit Precoding Matrix Indicator (TPMI) and/or number of layers which are indicated by the Precoding information and number of layers field in DCI format 0_1 and DCI format 0_2. If the UE is configured with 2 PTRS ports, the actual PTRS port(s) and the associated transmission layer(s) are derived from indicated TPMI as:
PUSCH antenna port 1000 and 1002 in indicated TPMI share PTRS port 0, and PUSCH antenna port 1001 and 1003 in indicated TPMI share PTRS port 1.
PTRS port 0 is associated with a DMRS port which are transmitted with PUSCH antenna port 1000 and PUSCH antenna port 1002 in indicated TPMI, and PTRS port 1 is associated with another DMRS port which are transmitted with PUSCH antenna port 1001 and PUSCH antenna port 1003 in indicated TPMI, where the two DMRS ports are given by DCI parameter ‘PTRS DMRS association’ in DCI format 0_1 and DCI format 0_2 in Table 7.3.1.1.2-26 of 3gpp TS 38.212 e.g. V17.2.0 (2022-06), which is reproduced below.

TABLE 7.3.1.1.2-26
PTRS-DMRS association for UL PTRS ports 0 and 1

| Value | | Value | |
|---|---|---|---|
| of MSB | DMRS port | of LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

### NR Rel-17 and Rel-18 Enhancements for PUSCH Transmission Towards Two TRPs

In NR Rel-17, support for PUSCH repetition to two transmission-reception points (TRPs) was introduced. For that purpose, two SRS resource sets with usage set to either codebook or non-codebook-based was introduced, where each SRS resource set is associated with a TRP. PUSCH repetition to two TRPs can be scheduled by a DCI with two SRS resource indicators (SRIs), where a first SRI is associated with a first SRS resource set and a second SRI associated with a second SRS resource set.

In NR Rel-18, simultaneous multi-panel UL transmission will be specified, where the UE will transmit PUSCH to two different TRPs simultaneously from two different UE panels. It is expected that the transmission from each UE panel is associated with either one SRS resource set (i.e., one SRS resource set per UE panel/TRP, as in Rel-17 PUSCH repetition) or with one SRS resource (i.e., one SRS resource per UE panel/TRP).

The present disclosure describes several methods on how to perform an overhead-efficient indication of a PTRS to DMRS mapping for UEs with up to 8 layers, up to 4 PTRS ports, up to 4 simultaneously transmitting UE panels, up to 4 UL codewords, and up to 8 layers per UE panel, which can reduce the DCI overhead for UL communication.

In one embodiment, for a single configured UL PTRS port and a single configured UL codeword, the number of entries of the associated PTRS DMRS Association table is equal to the configured maximum number of UL layers.

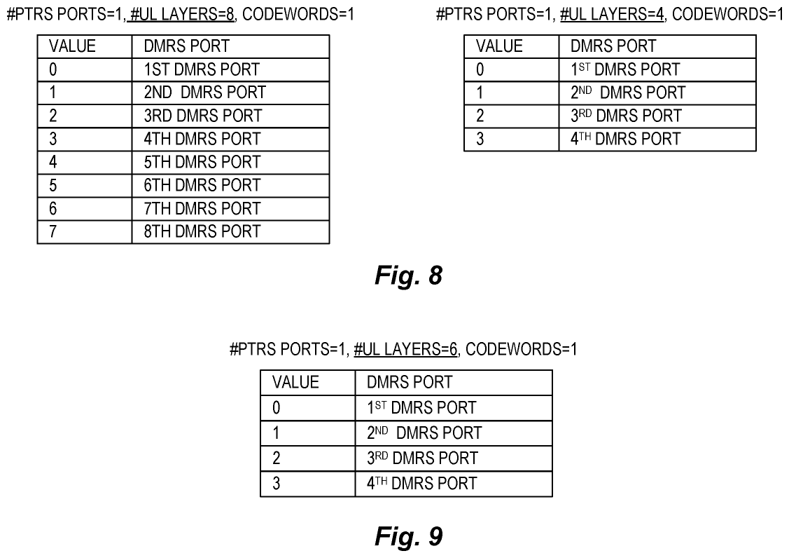

FIG. 8 illustrates two examples of PTRS DMRS mapping. The table on the left in FIG. 8 is for UE configured with one PTRS port, one codeword, and maximum 8 UL layers, which results in 8 entries of the PTRS DMRS Association table. The table on the right in FIG. 8 is for UE configured with one PTRS port, one codeword, and maximum 4 UL layers which results in 4 entries of the PTRS DMRS Association table. In one embodiment, different tables are provided for each possible configuration of maximum number of UL layers.

Currently in NR, PTRSs are mainly targeting millimeter wave (mmWave) frequencies. Also, since one PTRS is typically enough per UE panel (i.e., per local oscillator (LO)), and since a UE panel typically is equipped with 2 transmit (TX) chains, support for single PTRS and up to 8 layers might be seen as unnecessary in NR. However, new frequency bands between Frequency Range 1 (FR1) and Frequency Range 2 (FR2) will be specified in NR (6 GHz-24 GHZ), where there might be antenna architectures that use up to 8 ports for one UE panel, while still requiring PTRS. In addition, digital beamforming might become available also at very high frequencies in 6G. therefore, it is possible that up to 8 layers might be needed for single PTRS port in 6G.

Because the required number of codepoints for the PTRS-to-UL-layer mapping bitfield (e.g., the “PTRS-DMRS Association” bitfield in DCI format 0_1, 0_2 in NR) depends on the number of entries in the PTRS DMRS Association table, the required number of bits for the PTRS-to-UL-layer mapping can be reduced when configuring the UE with fewer number of maximum UL layers, which will reduce DCI overhead when a UE is configured with less than its supported maximum number of UL layers.

In one embodiment, the number of entries in the PTRS DMRS Association table is configurable. For example, even if the UE is configured with a maximum of 8 UL layers, it is possible to have and RRC configuration where the maximum number of layers that the PTRS can be associated with (i.e., the number of entries in the PTRS DMRS Association table) is configured to a lower number. In one example, even though a UE is configured with a maximum of 8 UL layers, the UE is configured with only 4 entries in the PTRS DMRS Association-table, which means that the UE only can be indicated with a PTRS to DMRS mapping associated with one of the 4 first DMRS ports (which will reduce the DCI overhead from 3 to 2 bits). This could be useful, for example, if the UE can determine the strongest UL layers based on DL reception and reciprocity. In this case, the UE can adapt the SRS transmission in such a way that the SRS ports with lowest SRS port index(es) (in case of non-coherent codebook-based UL transmission) or the SRS resource(s) with lowest SRS resource index(es) (in case of non-codebook-based UL transmission) is associated with the strongest UL layers.

In one embodiment, for a single configured UL PTRS port and a single configured UL codeword, the number of entries of a PTRS DMRS Association table is automatically equal to the configured maximum number of UL layers but rounded down to a number that is a factor of 2 (i.e., 2, 4, 8, etc.). FIG. 9 illustrates a PTRS DMRS Association table where a UE is configured with one PTRS port, on UL codeword, a maximum of 6 UL layers, and where the 4 first layers only can be associated with a PTRS. This mapping reduces the number of bits required to indicate the PTRS to DMRS mapping (e.g., the PTRS DMRS Association bitfield in DCI format 0_1 In NR) in an overhead efficient way. For example, if the UE is configured with maximum 6 UL layers, the UE would otherwise require 6 codepoints (3 bits) in the PTRS-to-UL-layer mapping bitfield. In this example, however, the number of codepoints are rounded down to four, which means that 2 bits are needed instead of 3.

In some embodiments, for a single configured UL PTRS port, the number of entries in a PTRS DMRS Association table is equal to the configured maximum number of UL layers divided by the configured maximum number of UL codewords. The entries of the PTRS DMRS Association table are associated with UL layers associated with the UL codeword with highest MCS (since the strongest UL layers most likely is associated with the strongest UL codeword).

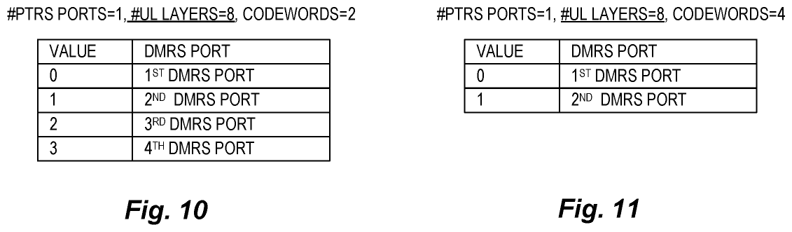

FIG. 10 illustrates one example of a PTRS DMRS Association table where a UE is configured with one PTRS port, maximum 8 UL layers and two UL codewords, and where the number of entries is equal to maximum number of UL layers (8) divided by number of UL codewords (2), e.g., 8/2=4. In this example, the entries in the table are associated with the UL layers associated with the UL codeword with the highest Modulation Coding Scheme (MCS). This mapping will reduce the number of required bits needed in the PTRS to DMRS mapping (e.g., the PTRS DMRS Association bitfield in DCI format 0_1 In NR) from 3 to 2 bits. Where two UL codewords have the same MCS, one of them can be selected based on another criteria. For example, where two UL codewords share the same (e.g., highest) MCS, one can be selected based on lowest codeword identifier (ID).

FIG. 11 illustrates a PTRS DMRS Association table for one PTRS port, four UL codewords, and a maximum 8 UL layers, where the number of entries in the table are equal to the maximum number of UL layers divided by the number of UL codewords. In this example, the entries in the table are associated with the UL layers associated with the UL codeword with highest MCS, according to some embodiments of the present disclosure.

In one embodiment, the UE has reported the capability Reciprocity based PTRS to UL layer mapping. In this case, it is assumed that the UE can determine the strongest UL layer(s) based on DL reception. Based on the determined strongest layer, the UE adapts the SRS port/resource to UE antenna mapping in such a way that the PTRS is associated with the strongest UL layer(s). By adapting the mapping at the UE, there is no need for the network to indicate to the UE which UL layer the UE should associate the PTRS with, and hence the PTRS-to-UL-layer mapping bitfield can be removed (which saves DCI overhead).

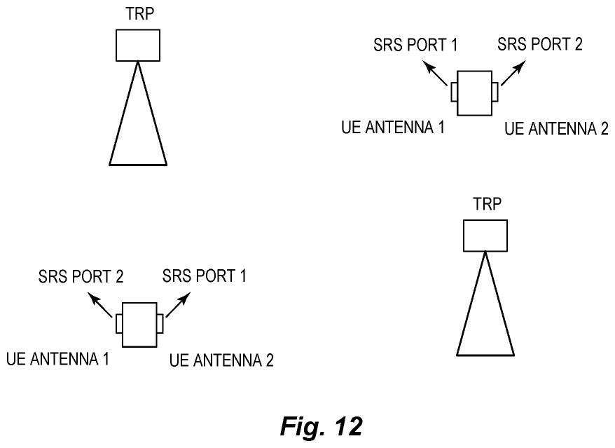

FIG. 12 illustrates an exemplary embodiment according to the present disclosure, where the UE adapts the SRS port to antenna port mapping to make sure that the UE antenna with strongest link to the serving TRP is associated with the SRS port with lowest SRS port index, such that the PTRS always is mapped to the strongest layer. This example is for a non-coherent UE with two UE antennas, where the UE is configured with one two-port SRS resource with usage ‘codebook’. The UE is configured with a non-coherent codebook, and hence can be scheduled with one of the following candidate precoders: [1,0] (i.e., single-layer PUSCH transmission on the first UE antenna), [0,1] (i.e. single layer PUSCH transmission on the second UE antenna) or [1,1] (i.e. two-layer PUSCH transmission, one layer per antenna). It is further assumed that the UE is configured with one PTRS port. In case the UE is scheduled for a two-layer UL transmission (i.e., precoder [1,1]), a bitfield in DCI (PTRS-to-UL-layer mapping bitfield) would traditionally be used to indicate which is the strongest UL layer, and hence which UL layer (or DMRS port) the UE should associated the PTRS with. However, in this example, the UE use DL reception to determine which UE antenna is strongest, and maps the SRS port with lowest SRS port ID to that UE antenna. In this way, if it is assumed that the PTRS should be associated with the first indicated DMRS port for PUSCH which is associated with the SRS port with lowest SRS port ID, then the UE automatically will allocate the PTRS to the stronger UL layer, and the DCI indication (PTRS-to-UL-layer mapping bitfield) can be removed. This is illustrated in FIG. 12 where a UE in a first situation detects that UE antenna 1 has the strongest link to the serving TRP (based on e.g., DL reception) and therefore transmit SRS port 1 from UE antenna 1. In a second situation (bottom of FIG. 12), the UE detects that UE antenna 2 is the has the strongest link to the serving TRP, and then maps SRS port 1 to UE antenna 1. In both these cases, if the UE is configured with a single PTRS and scheduled with rank 2, the PTRS will automatically be associated with the strongest layer (first DMRS port) which means that no DCI indication (PTRS-to-UL-layer mapping bitfield) for PTRS is needed.

FIG. 12 illustrates SRS port to antenna port mapping for a single PTRS and the strongest UL layer, however SRS port to antenna port mapping can easily be extended to cases where N PTRS are mapped to the N strongest layers. Similarly, FIG. 12 assumes a non-coherent codebook, however SRS port to antenna port mapping can be performed in a similar way for partially coherent or fully coherent UL codebooks. For a fully coherent UE, the UE needs to determine the phase of each SRS for each antenna port in a such a way that the strongest precoder will correspond to the first column in the precoding matrix as specified (TS 38.211 e.g. V17.2.0 (2022-06) Table 6.3.1.5-4 to Table 6.3.1.5-7).

In one embodiment, the same method is used for non-codebook-based UL transmission, where the UE determines SRS precoders based on the DL reference signal measurements and reciprocity. By transmitting the SRS port/resource with lowest SRS port/SRS resource index in the strongest direction towards the network, the PTRS will be automatically associated with the strongest layer, and the PTRS-to-UL-layer mapping bitfield can be removed. This approach can easily be extended to X number of PTRS by precoding the X SRS ports/resources with lowest SRS port IDs/resource IDs in the X strongest directions.

### Embodiments Related to 2 PTRS Ports

In one embodiment, for two configured UL PTRS ports, a single configured UL codeword, and where the UE is equipped with 4 UE panels/UE antenna modules (for simultaneous UL transmission), the PTRS DMRS Association table and corresponding PTRS-to-UL-layer mapping bitfield is divided into multiple parts: A first part is used to indicate which of the multiple UE panel(s)/UE antenna modules that the PTRS should be associated with. The remaining parts indicate which UL layers associated with the indicated UE panel(s)/UE antenna modules that the PTRS should be associated with.

In some embodiments, the first part of the table/bitfield may be associated with a UL-RS (SRS) resource set or UL-RS (SRS) resource). Hence, the first part of the table/bitfield might be used to indicate an UL-RS resource set or an UL-RS resource instead of UE panel. It is also possible that an explicit UE panel ID or virtual UE panel ID is introduced in NR or 6G, in this case the first part of the table/bitfield might be used to indicate a virtual UE panel ID or an explicit UE panel ID

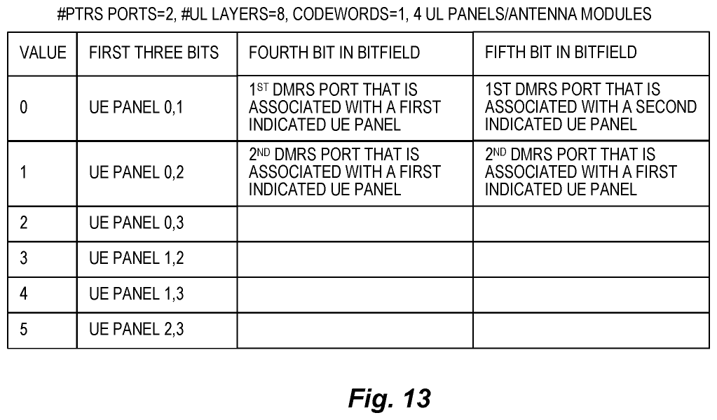

FIG. 13 illustrates an example PTRS-DMRS Association table for one PTRS port, one UL codeword, maximum 8 UL layers, and 4 UE panels/antenna modules. A first part of the table is used to indicate which UE panels/UE antenna modules the PTRSs should be associated with, and the remaining parts indicates which UL layer of the indicated UE panels/UE antenna modules the PTRS should be associated with. In this case, the first three bits of the PTRS-to-UL-layer mapping bitfield is used to indicate which UE panels/UE antenna modules the fourth and fifth bit of the PTRS-to-UL-layer mapping bitfield is associated with. This will reduce the required number of bits compared to explicitly indicate which DMRS port a first PTRS port should be associated with (8 codepoints) and then indicate which DMRS port the second PTRS port should be indicated with (6 codepoints), which requires 6 bits (instead of 5 bits that is required in this example).

In some embodiments, the UE panel is not explicitly defined in the specification. Instead, the UE panel indication could be associated with an SRS resource set or SRS resource. In this case, for example, instead of a UE panel ID in the table in FIG. 13, an SRS resource ID and/or SRS resource set ID could be used instead in the specification.

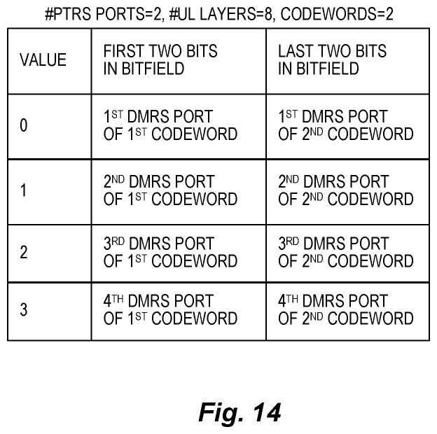

In one embodiment illustrated, for two configured UL PTRS ports and two configured UL codewords, the entries of the PTRS DMRS Association table is divided into two parts, where a first part is used to indicate the PTRS to DMRS mapping for the first codeword, and the second part of the is used to indicate the PTRS to DMRS mapping for the second codeword. FIG. 14 illustrates an example PTRS-DMRS Association table for two UL PTRS ports and two UL codewords, where the entries of the PTRS-DMRS Association table are divided into two parts, A first part indicates the PTRS to DMRS mapping for the first codeword, and the second part indicates the PTRS to DMRS mapping for the second codeword

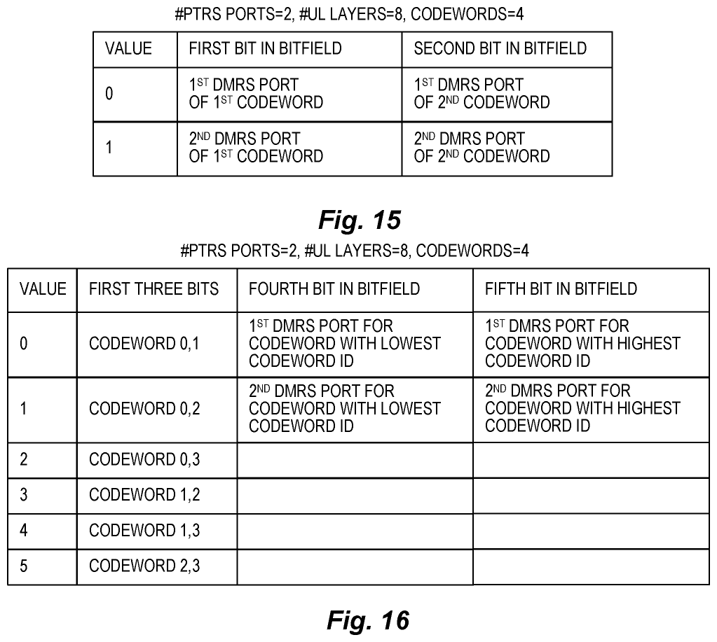

In one embodiment illustrated in FIG. 15, for two configured UL PTRS ports and four configured UL codewords, the entries of the PTRS DMRS Association table are divided into two parts. The first part indicates the PTRS to DMRS mapping for a first codeword, and the second part indicates the PTRS to DMRS mapping for a second codeword. The first codeword is the codeword with highest MCS, and the second codeword is the codeword with the second highest MCS. In case two UL codewords have the same MCS, one of them are selected based on another criteria, for example based on lowest codeword ID.

In one embodiment illustrated in FIG. 16, for two configured UL PTRS ports and four configured UL codewords, the PTRS DMRS Association table is divided into multiple parts. A first part indicates which of the codewords that the PTRSs should be associated with. The remaining parts indicate which UL layers associated with the indicated codewords that the PTRSs should be associated with. In FIG. 16, the first three bits of the PTRS-to-UL-layer mapping bitfield is used to indicate which codewords the fourth and fifth bit of the PTRS-to-UL-layer mapping bitfield is associated with. This will reduce the required number of bits compared to explicitly indicate which DMRS port a first PTRS port should be associated with (8 codepoints) and then indicate which DMRS port the second PTRS port should be indicated with (6 codepoints), which requires 6 bits (instead of 5 bits that is required in this example).

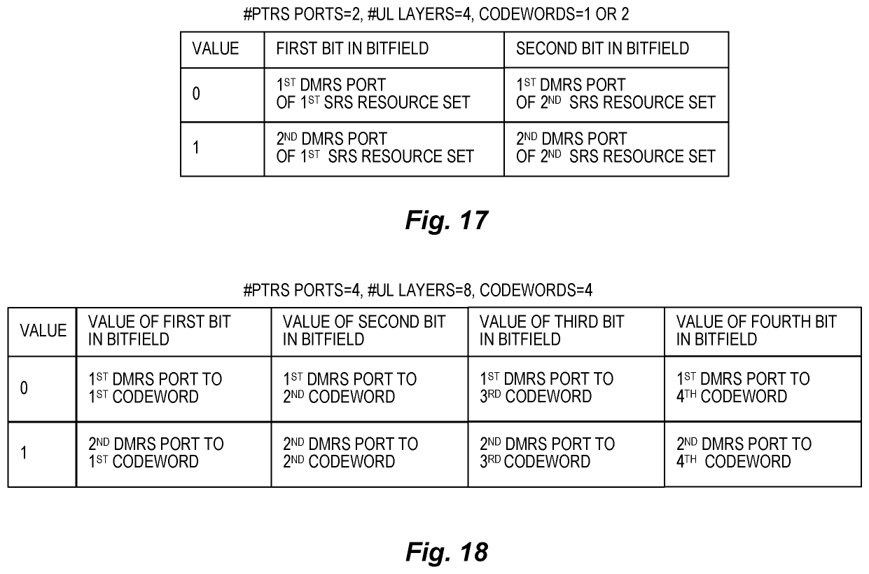

In one embodiment illustrated in FIG. 17, the UE is configured with two UL PTRS ports and two SRS resource sets for simultaneous transmission from multiple panels (STxMP) on up to 4 layers in total with a maximum of two layers per UE panel. The UE is configured with two SRS resource sets, each with two SRS ports, with usage “codebook and/or ‘non-codebook’. In this case the first bit of the PTRS-to-UL-layer mapping bitfield is used to indicate which of the two layers associated with the first SRS resource set the first PTRS should be mapped to, and the second bit of the PTRS-to-UL-layer mapping bitfield is used to indicate which of the two layers associated with the second SRS resource set the second PTRS should be mapped to. In one embodiment, the SRS resource set is changed to SRS resource.

### Embodiments Related to 4 PTRS Ports

Four PTRS ports might be introduced in 5G advance and/or 6G to handle UEs with 4 panels or 4 antenna modules (where the UE can transmit from all 4 panels/antenna modules simultaneously).

In one embodiment illustrated in FIG. 18, for four configured UL PTRS ports and four configured UL codewords, the entries of the PTRS DMRS Association table is divided into four parts, where a first part is used to indicate the PTRS to DMRS mapping for a first codeword, the second part is used to indicate the PTRS to DMRS mapping for the second codeword, the third part of the is used to indicate the PTRS to DMRS mapping for the third codeword and the fourth part of the is used to indicate the PTRS to DMRS mapping for the fourth codeword.

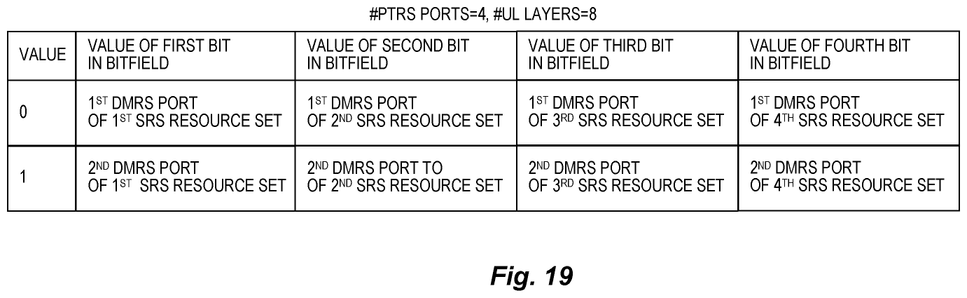

In one embodiment illustrated in FIG. 19, the UE is configured with four UL PTRS ports and four SRS resource sets for STxMP operation on up to 8 layers in total, with up to four UE panels and maximum two layers per UE panel. The UE is configured with four SRS resource sets (each with a two SRS ports) with usage “codebook and/or ‘non-codebook’. In this case the first bit of the PTRS-to-UL-layer mapping bitfield is used to indicate which of the two layers associated with the first SRS resource set the first PTRS should be mapped to, the second bit of the PTRS-to-UL-layer mapping bitfield is used to indicate which of the two layers associated with the second SRS resource set the second PTRS should be mapped to, the third bit of the PTRS-to-UL-layer mapping bitfield is used to indicate which of the two layers associated with the third SRS resource set the third PTRS should be mapped to, the fourth bit of the PTRS-to-UL-layer mapping bitfield is used to indicate which of the two layers associated with the fourth SRS resource set the fourth PTRS should be mapped to. In one embodiment, the SRS resource set is changed to SRS resource.

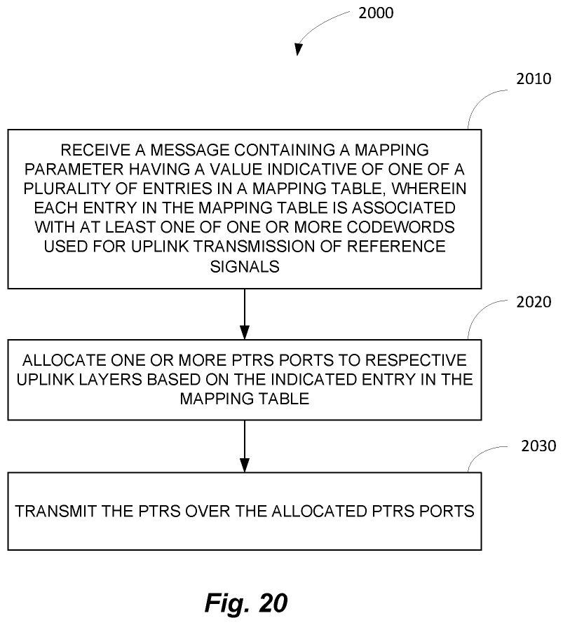

FIG. 20 illustrates a method 2000 for transmitting PTRS implemented by a wireless device in a wireless communication system using multi-layer transmission on the uplink, according to one exemplary embodiment of the present disclosure. The method comprises receiving 2010 a message containing a mapping parameter having a value indicative of one of a plurality of entries in a mapping table. Each entry in the mapping table is associated with at least one of one or more codewords used for uplink transmission of reference signals. The one or more codewords may comprise a plurality (e.g., two or more) of codewords. The method further comprises, allocating 2020 one or more PTRS ports to respective uplink layers based on the indicated entry in the mapping table and transmitting 2030 the PTRS over the allocated PTRS ports.

In some embodiments of method 2000, a number of entries in the mapping table is less than a number of configured uplink layers.

In some embodiments of method 2000, a number of entries in the mapping table equals a number of configured uplink layers divided by a number of codewords used for uplink data transmissions.

In some embodiments of method 2000, a number of PTRS ports is 1, the entries in the mapping table are associated with a codeword of the one or more codewords with the highest modulation and coding scheme (MCS).

In some embodiments of method 2000, the number of entries in the mapping table equals the maximum number of codewords in a configured uplink layer.

In some embodiments of method 2000, when the highest MCS is shared by two or more codewords of the one or more codewords, the entries in the mapping table are associated with one of the two or more codewords with the lowest codeword index.

In some embodiments of method 2000, when the MCS are the same for the one or more codewords, and the entries in the mapping table are associated a codeword of the one or more codewords having the lowest codeword index.

In some embodiments of method 2000, allocating one or more PTRS ports to respective uplink layers based on the indicated entry in the mapping table comprises determining the uplink codeword with the highest MCS and allocating the PTRS to an uplink layer associated with the uplink codeword with the highest MCS.

In some embodiments of method 2000, a number of PTRS ports is n>1, the entries in the mapping table are associated with n codewords of the one or codewords having the highest MCSs.

In some embodiments of method 2000, the number of entries in the mapping table equals the maximum number of codewords in n uplink layers.

In some embodiments of method 2000, when two or more codewords of the one or more codewords share the highest MCS, the entries in the mapping table are associated with one of the two or more codewords with the lowest codeword index.

In some embodiments of method 2000, allocating one or more PTRS ports to respective uplink layers based on the indicated entry in the mapping table comprises determining the codeword with the highest MCS and allocating the PTRS to an uplink layer associated with the codeword with the highest MCS.

In some embodiments of method 2000, the mapping parameter comprises a first part indicating which of multiple codewords are associated with the entries in the mapping table, and a second part indicating one or more uplink layers associated with the codeword(s) indicated by the first part.

In some embodiments of method 2000, the mapping parameter comprises a bitmap indicating an uplink layer associated each of a plurality of codewords.

In some embodiments of method 2000, the bitmap indicates an uplink layer associated with first and second codewords with the highest modulation and coding scheme.

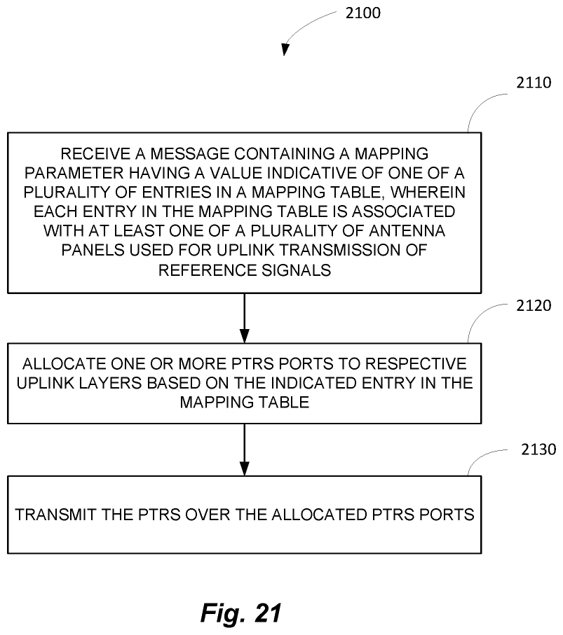

FIG. 21 illustrates another exemplary method 2100 for transmitting PTRS implemented by a wireless device in a wireless communication system using multi-layer transmission on the uplink. The method comprises receiving 2110 a message containing a mapping parameter having a value indicative of one of a plurality of entries in a mapping table. Each entry in the mapping table is associated with at least one of a plurality of antenna panels used for uplink transmission of reference signals. The method further comprises, allocating 2120 one or more PTRS ports to respective uplink layers based on the indicated entry in the mapping table and transmitting 2130 the PTRS over the allocated PTRS ports.

In some embodiments of method 2100, the mapping parameter comprises a first part indicating which of multiple antenna panels are associated with the entries in the mapping table, and a second part indicating one or more uplink layers associated with the antenna panels(s) indicated by the first part.

In some embodiments of method 2100, the second part comprises a bitmap indicating an uplink layer for each antenna panel indicated by the first part.

In some embodiments of method 2100, the bitmap comprises a single bit for each antenna panel indicating an uplink layer associated with the antenna panel.

In some embodiments of method 2100, the mapping parameter comprises a bitmap indicating an uplink layer for each of two or more antenna panels.

In some embodiments of method 2100, the antenna panel is indicated by a sounding reference signal resource or sounding reference signal resource set.

In some embodiments of method 2100, when the wireless device is configured with two PTRS ports and configured for STxMP operation, a first bit in the bitmap indicates an association between PTRS port 0 and DMRS port(s) associated with a first TPMI/SRI field, and a second bit in the bitmap indicates an association between PTRS port 1 and the DMRS port(s) associated with a second TPMI/SRI field

In some embodiments of method 2100, when the wireless device is configured with four PTRS ports and configured for STxMP operation, a first bit in the bitmap indicates the association between PTRS port 0 and the DMRS port(s) associated with a first TPMI/SRI field, a second bit in the bitmap indicates the association between PTRS port 1 and the DMRS port(s) associated with the second TPMI/SRI field, and a third bit in the bitmap indicates an association between PTRS port 2 and the demodulation reference signal (DMRS) port(s) associated with the third TPMI/SRI field, and a the fourth bit in the bitmap indicates the association between PTRS port 3 and the DMRS port(s) associated with the fourth TPMI/SRI field.

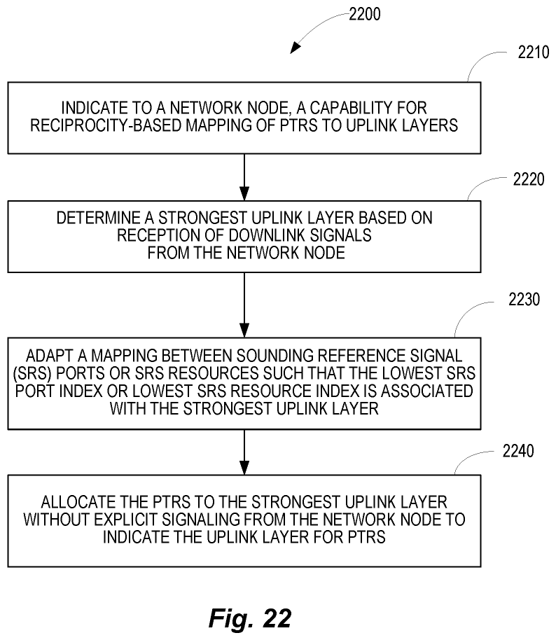

FIG. 22 illustrates another exemplary method 2200 for transmitting PTRS implemented by a wireless device in a wireless communication systems using multi-layer transmission on the uplink. The method comprises indicating 2210 to a network node, a capability for reciprocity based mapping of PTRS to uplink layers. The method further comprises, determining 2220 a strongest uplink layer based on reception of downlink signals from the network node. The method further comprises, adapting 2230 a mapping between SRS ports or SRS resources such that the lowest SRS port index or lowest SRS resource index is associated with the strongest uplink layer. The method further comprises, allocating 2240 the PTRS to the strongest uplink layer without explicit signaling from the network node to indicate the uplink layer for PTRS.

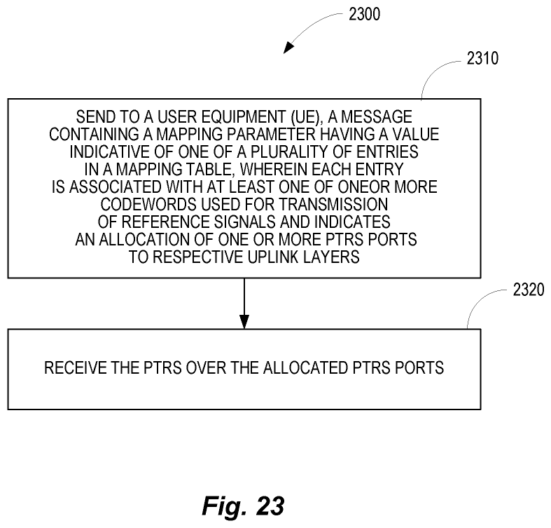

FIG. 23 illustrates another exemplary method 2300 for receiving PTRS implemented by a network node in a wireless communication systems using multi-layer transmission on the uplink. The method comprises, sending 2310, to a UE, a message containing a mapping parameter having a value indicative of one of a plurality of entries in a mapping table. Each entry in the mapping table is associated with at least one of one or more codewords used for uplink transmission of reference signals and indicates an allocation of one or more PTRS ports to respective uplink layers. The one or more codewords may comprise a plurality (e.g., two or more) of codewords. The method further comprises, receiving 2320 the PTRS over the allocated PTRS ports.

In some embodiments of method 2300, a number of entries in the mapping table is less than a number of configured uplink layers.

In some embodiments of method 2300, a number of entries in the mapping table equals a number of configured uplink layers divided by a number of codewords used for uplink data transmissions.

In some embodiments of method 2300, a number of PTRS ports is 1, the entries in the mapping table are associated with a codeword of the one or more codewords with the highest modulation and coding scheme (MCS).

In some embodiments of method 2300, the number of entries in the mapping table equals the maximum number of codewords in a configured uplink layer.

In some embodiments of method 2300, when the highest MCS is shared by two or more codewords of the one or more codewords, the entries in the mapping table are associated with one of the two or more codewords with the lowest codeword index.

In some embodiments of method 2300, when the MCS are the same for the one or more codewords, and the entries in the mapping table are associated a codeword of the one or more codewords having the lowest codeword index.

In some embodiments of method 2300, when a number of PTRS ports is n>1, the entries in the mapping table are associated with n codewords in the plurality of codewords having the highest MCSs.

In some embodiments of method 2300, the number of entries in the mapping table equals the maximum number of codewords in n uplink layers.

In some embodiments of method 2300, when two codewords share the same MCS, the entries in the mapping table are associated with the one with the lowest codeword index in the plurality of codewords with the highest modulation and coding scheme (MCS).

In some embodiments of method 2300, the mapping parameter comprises a first part indicating which of multiple codewords are associated with the entries in the mapping table, and a second part indicating one or more uplink layers associated with the codeword(s) indicated by the first part.

In some embodiments of method 2300, the mapping parameter comprises a bitmap indicating an uplink layer associated each of a plurality of codewords.

In some embodiments of method 2300, the bitmap indicates an uplink layer associated with first and second codewords with the highest modulation and coding scheme.38.

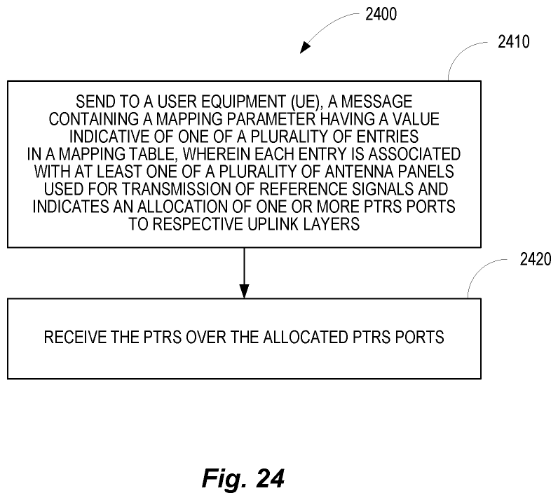

FIG. 24 illustrates another exemplary method 2400 for receiving PTRS implemented by a network node in a wireless communication systems using multi-layer transmission on the uplink. The method comprises, sending 2410, to a UE, a message containing a mapping parameter having a value indicative of one of a plurality of entries in a mapping table. Each entry is associated with at least one of a plurality of antenna panels used for uplink transmission of reference signals and indicates an allocation of one or more PTRS ports to respective uplink layers. The method further comprises, receiving 2420 the PTRS over the allocated PTRS ports.

In some embodiments of method 2400, the mapping parameter comprises a first part indicating which of multiple antenna panels are associated with the entries in the mapping table, and a second part indicating one or more uplink layers associated with the antenna panels(s) indicated by the first part.

In some embodiments of method 2400, the second part comprises a bitmap indicating an uplink layer for each antenna panel indicated by the first part.

In some embodiments of method 2400, the bitmap comprises a single bit for each antenna panel indicating an uplink layer associated with the antenna panel.

In some embodiments of method 2400, the mapping parameter comprises a bitmap indicating an uplink layer for each of two or more antenna panels.

In some embodiments of method 2400, the antenna panel is indicated by a sounding reference signal resource or sounding reference signal resource set. In some embodiments of method 2400, when the wireless device is configured with two PTRS ports and configured for STxMP operation, a first bit in the bitmap indicates an association between PTRS port 0 and DMRS port(s) associated with a first TPMI/SRI field, and a second bit in the bitmap indicates an association between PTRS port 1 and the DMRS port(s) associated with a second TPMI/SRI field

In some embodiments of method 2400, when the wireless device is configured with four PTRS ports and configured for STxMP operation, a first bit in the bitmap indicates the association between PTRS port 0 and the DMRS port(s) associated with a first TPMI/SRI field, a second bit in the bitmap indicates the association between PTRS port 1 and the DMRS port(s) associated with the second TPMI/SRI field, and a third bit in the bitmap indicates an association between PTRS port 2 and the demodulation reference signal (DMRS) port(s) associated with the third TPMI/SRI field, and a the fourth bit in the bitmap indicates the association between PTRS port 3 and the DMRS port(s) associated with the fourth TPMI/SRI field.

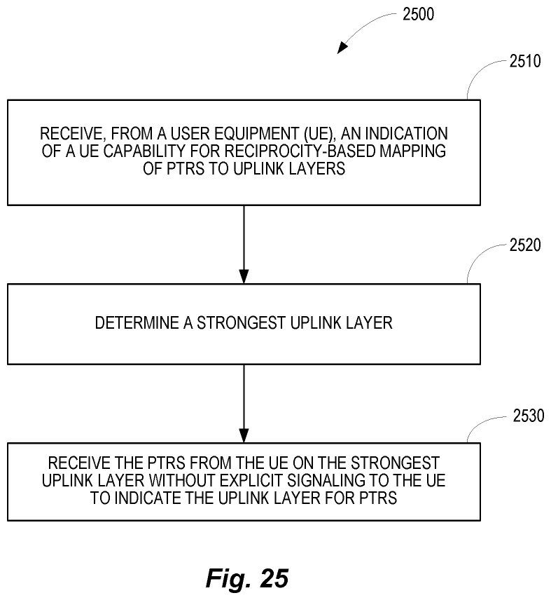

FIG. 25 illustrates another exemplary method 2500 receiving PTRS implemented by a network node in a wireless communication systems using multi-layer transmission on the uplink. The method comprises receiving 2510, from a UE, an indication of a UE capability for reciprocity based mapping of PTRS to uplink layers. The method further comprises, determining 2520 a strongest uplink layer. The method further comprises, receiving 2530 the PTRS from the UE on the strongest uplink layer without explicit signaling to the UE to indicate the uplink layer for PTRS.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

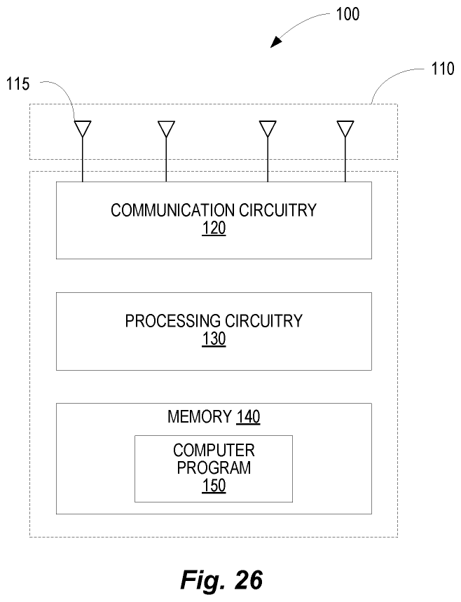

FIG. 26 illustrates a UE 100 according to an exemplary embodiment. The UE 100 generally comprises one or more antenna panels 110, each comprising a plurality of antenna or antenna elements 115, communication circuitry 120 for communicating with the network over a wireless communication channel, processing circuitry 130 for controlling the operation of the UE 100 and memory 140 for storing programs and data needed by the UE 100.

The communication circuitry 120 couples to the antenna panel(s) 110 and comprises the radio frequency circuitry needed for communicating with the network over a wireless channel. The radio frequency circuitry may comprise an RF transmitter and RF receiver configured to operate according to 5G standards or other applicable standards.

The processing circuitry 130 controls the overall operation of the UE 100. The processing circuitry 130 may comprise one or more microprocessors, hardware, firmware, or a combination thereof. In representative embodiments, the UE 100 is configured to perform one or more of the methods of FIGS. 20-22.

Memory 140 comprises both volatile and non-volatile memory for storing computer program code and data needed by the processing circuitry 130 for operation. Memory 140 may comprise any tangible, non-transitory computer-readable storage medium for storing data including electronic, magnetic, optical, electromagnetic, or semiconductor data storage. Memory 140 stores computer program 150 comprising executable instructions that configure the processing circuitry 130 to implement one or more of the methods herein described. A computer program 150 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 150 for configuring the processing circuitry 130 as herein described may be stored in a removable memory, such as a portable compact disc, portable digital video disc, or other removable media. The computer program 150 may also be embodied in a carrier such as an electronic signal, optical signal, radio signal, or computer readable storage medium. In one embodiment, the computer program 150 configures the processing circuitry 130 to perform one or more of the methods of FIGS. 20-22.

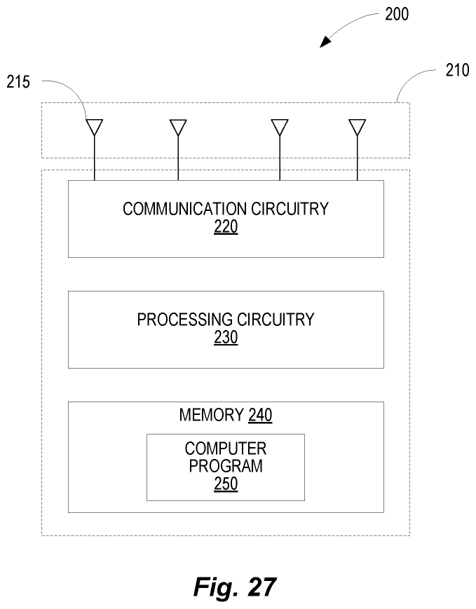

FIG. 27 illustrates a base station 200 according to an exemplary embodiment. The base station 200 generally comprises one or more antenna panels 210, each comprising a plurality of antenna or antenna elements 215, communication circuitry 220 for communicating with the network over a wireless communication channel, processing circuitry 230 for controlling the operation of the base station 200 and memory 240 for storing programs and data needed by the base station 200.

The communication circuitry 220 couples to the antenna panel 210 and comprises the radio frequency circuitry needed for communicating with the network over a wireless channel. The radio frequency circuitry may comprise an RF transmitter and RF receiver configured to operate according to 5G standards or other applicable standards.

The processing circuitry 230 controls the overall operation of the base station 200. The processing circuitry 230 may comprise one or more microprocessors, hardware, firmware, or a combination thereof. In representative embodiments, the base station 200 is configured as a UDR and the processing circuitry 230 is configured to perform one or more of the methods of FIGS. 23-25.

Memory 240 comprises both volatile and non-volatile memory for storing computer program code and data needed by the processing circuitry 230 for operation. Memory 240 may comprise any tangible, non-transitory computer-readable storage medium for storing data including electronic, magnetic, optical, electromagnetic, or semiconductor data storage. Memory 240 stores computer program 250 comprising executable instructions that configure the processing circuitry 230 to implement one or more of the methods herein described. A computer program 250 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 250 for configuring the processing circuitry 230 as herein described may be stored in a removable memory, such as a portable compact disc, portable digital video disc, or other removable media. The computer program 250 may also be embodied in a carrier such as an electronic signal, optical signal, radio signal, or computer readable storage medium. In one embodiment, the computer program 250 configures the processing circuitry 230 to perform one or more of the methods of FIGS. 23-25.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

1.-72. (canceled)

73. A method of transmitting a phase tracking reference signal (PTRS) using multi-layer transmission on an uplink, the method implemented by a wireless device in a wireless communication system, the method comprising:
receiving a message containing a mapping parameter having a value indicative of one of a plurality of entries in a mapping table, wherein each entry in the mapping table is associated with at least one of one or more codewords used for uplink transmission of reference signals;
allocating one or more PTRS ports to respective uplink layers based on the indicated entry in the mapping table; and
transmitting the PTRS over the one or more allocated PTRS ports.

74. The method of claim 73, wherein a number of entries in the mapping table is less than a number of configured uplink layers.

75. The method of claim 74, wherein a number of entries in the mapping table equals a number of configured uplink layers divided by a number of codewords used for uplink data transmissions.

76. The method of claim 75, wherein, when a number of PTRS ports is 1, the entries in the mapping table are associated with a codeword of the one or more codewords with the highest modulation and coding scheme (MCS).

77. The method of claim 76, wherein the number of entries in the mapping table equals the maximum number of codewords in a configured uplink layer.

78. The method of claim 76, wherein, when the highest MCS is shared by two or more codewords of the one or more codewords, the entries in the mapping table are associated with one of the two or more codewords with the lowest codeword index.

79. The method of claim 76, wherein, when the MCS is the same for the one or more codewords, the entries in the mapping table are associated a codeword of the one or more codewords having the lowest codeword index.

80. The method of claim 76, wherein allocating one or more PTRS ports to respective uplink layers based on the indicated entry in the mapping table comprises:
determining the codeword with the highest MCS; and
allocating the PTRS to an uplink layer associated with the uplink codeword with the highest MCS.

81. The method of claim 73, wherein the mapping parameter comprises a bitmap indicating an uplink layer associated with each of a plurality of codewords.

82. The method of claim 81, wherein the bitmap indicates an uplink layer associated with first and second codewords with the highest modulation and coding scheme.

83. A method of receiving a phase tracking reference signal (PTRS) using multi-layer transmission on an uplink, the method implemented by a network node in a wireless communication system, the method comprising:
sending, to a user equipment (UE), a message containing a mapping parameter having a value indicative of one of a plurality of entries in a mapping table, wherein each entry is associated with at least one of one or more codewords used for uplink transmission of reference signals and indicates an allocation of one or more PTRS ports to respective uplink layers; and
receiving the PTRS over the one or more allocated PTRS ports.

84. The method of claim 83, wherein a number of entries in the mapping table is less than a number of configured uplink layers.

85. The method of claim 84, wherein a number of entries in the mapping table equals a number of configured uplink layers divided by a number of codewords used for uplink data transmissions.

86. The method of claim 85, wherein, when a number of PTRS ports is 1, the entries in the mapping table are associated with a codeword of the one or more codewords with the highest modulation and coding scheme (MCS).

87. The method of claim 86, wherein the number of entries in the mapping table equals the maximum number of codewords in a configured uplink layer.

88. The method of claim 86, wherein, when the highest MCS is shared by two or more codewords of the one or more codewords, the entries in the mapping table are associated with one of the two or more codewords with the lowest codeword index.

89. The method of claim 86, wherein, when the MCS are the same for the one or more codewords, and the entries in the mapping table are associated a codeword of the one or more codewords having the lowest codeword index.

90. The method of claim 83, wherein the mapping parameter comprises a bitmap indicating an uplink layer associated each of a plurality of codewords.

91. The method of claim 90, wherein the bitmap indicates an uplink layer associated with first and second codewords with the highest modulation and coding scheme.

92. A wireless device in a wireless communication system using multi-layer transmission on an uplink and configured to transmit a phase tracking reference signal (PTRS), the wireless device comprising:
communication circuitry for communicating with a network node; and
processing circuitry configured to:
receive a message containing a mapping parameter having a value indicative of one of a plurality of entries in a mapping table, wherein each entry in the mapping table is associated with at least one of a plurality of codewords used for uplink transmission of reference signals;
allocate one or more PTRS ports to respective uplink layers based on the indicated entry in the mapping table; and
transmit the PTRS over the one or more allocated PTRS ports.

93. The wireless device of claim 92, wherein a number of entries in the mapping table is less than a number of configured uplink layers.

94. The wireless device of claim 93, wherein a number of entries in the mapping table equals a number of configured uplink layers divided by a number of codewords used for uplink data transmissions.

95. The wireless device of claim 94, wherein, when a number of PTRS ports is 1, the entries in the mapping table are associated with a codeword of the one or more codewords with the highest modulation and coding scheme (MCS).

96. The wireless device of claim 95, wherein the number of entries in the mapping table equals the maximum number of codewords in a configured uplink layer.

97. The wireless device of claim 95, wherein, when the highest MCS is shared by two or more codewords of the one or more codewords, the entries in the mapping table are associated with one of the two or more codewords with the lowest codeword index.

98. A network node in a wireless communication system using multi-layer transmission on an uplink and configured to receive a phase tracking reference signal (PTRS) from a user equipment (UE), the network node comprising:
communication circuitry for communicating with the UE; and
processing circuitry configured to:
send, to the UE, a message containing a mapping parameter having a value indicative of one of a plurality of entries in a mapping table, wherein each entry is associated with at least one of a plurality of codewords used for uplink transmission of reference signals and indicates an allocation of one or more PTRS ports to respective uplink layers; and
receive the PTRS over the one or more allocated PTRS ports.
